(19) United States
(12) Patent Application Publication
(10) Pub. No.: US 2026/0330653 A1
(43) Pub. Date: Oct. 22, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: Kenji SUGIYAMA, Kanagawa (JP); Atsushi NOGAMI, Kanagawa (JP)

(21) Appl. No.: 19/570,555

(22) Filed: Mar. 18, 2026

(30) Foreign Application Priority Data
Apr. 21, 2025 (JP) 2025-069914

(51) Int. Cl. G06T 7/246; H04N 23/67

(52) U.S. Cl. CPC G06T 7/248; H04N 23/675

(57) ABSTRACT

An information processing apparatus including at least one memory storing instructions; and at least one processor executing the stored instructions causing the information processing apparatus to: detect tracking target candidates from each of a first image and a second image later in a time series than the first image, select a tracking target from the tracking target candidates, track the tracking target and determine a possibility of transfer of the tracking target, and perform highlighting for a user based on the possibility of transfer of the tracking target.

### BACKGROUND

### Field of the Technology

The present disclosure relates to an information processing apparatus, an information processing method, and a storage medium.

### Description of the Related Art

In recent years, cameras capable of automatically tracking a subject to be photographed and continuing to automatically focus on the subject are common. However, in a case in which a person that is a subject and another person pass by each other, and the like, focus is unintentionally aligned with the other person, and there are cases in which the tracking target transfers.

For example, in Japanese Patent No. 5047007, technology for displaying reliability of tracking processing on a screen is disclosed.

### SUMMARY

In order to solve the above-described problems, an information processing apparatus of the present disclosure comprises: at least one memory storing instructions; and at least one processor executing the stored instructions causing the information processing apparatus to: detect tracking target candidates from each of a first image and a second image later in a time series than the first image, select a tracking target from the tracking target candidates, track the tracking target, and together with the tracking, determine a possibility of transfer of the tracking target, and perform highlighting for a user based on the possibility of transfer of the tracking target.

Features of the present disclosure will become apparent from the following description of embodiments with reference to the attached drawings. The following description of embodiments is described by way of example.

### BRIEF DESCRIPTION OF THE DRAWINGS

FIG. 1 is a flowchart showing a flow of main processing in a First Embodiment.

FIGS. 2A, 2B, 2C, and 2D are flowcharts showing flows of partial processing in the First Embodiment.

FIG. 3 is a block diagram explaining a configuration of functional units in the First Embodiment.

FIG. 4 is a hardware configuration diagram of an information processing apparatus in the First Embodiment.

FIG. 5 is a diagram showing an example of detection of tracking target candidates in the First Embodiment.

FIGS. 6A, 6B, and 6C are diagrams explaining tracking processing in the First Embodiment.

FIGS. 7A and 7B are diagrams explaining detection of a whole body and a specific part in the First Embodiment.

FIGS. 8A and 8B are diagrams showing examples of highlighting in the First Embodiment.

### DESCRIPTION OF THE EMBODIMENTS

Hereinafter, the present disclosure is explained in detail based on preferred embodiments thereof with reference to the attached drawings. It should be noted that configurations shown in the following embodiments are merely examples, and the present disclosure is not limited to configurations shown in the drawings.

### First Embodiment

An embodiment of the present disclosure is explained. In the First Embodiment, in a process of detecting a specific part of a subject for the purpose of autofocus control (hereinafter denoted as AF control), the possibility of transfer is calculated and displayed. Furthermore, an example is shown in which, in a case in which a user determines that the tracking target has actually transferred, the tracking target is reset to a subject intended by a user. Here, “possibility of transfer” refers to the possibility that a tracking target is replaced with a subject different from a subject intended by a user. Specifically, for example, either a situation in which the possibility is high that the tracking target switches to (transfers to) another object, or a situation in which the possibility is high that the tracking target switched to (transferred to) another object, is a situation in which the possibility of transfer is high.

It is conveyed to a user that a situation in which the possibility of transfer of the tracking target is high exists, and the user determines whether or not transfer actually occurred, and instructs change of the tracking target, whereby tracking of the intended subject can be continued. In addition, as a result, focusing can be continued on the subject that the user wishes to photograph, and taking a photograph as the user intended becomes easier.

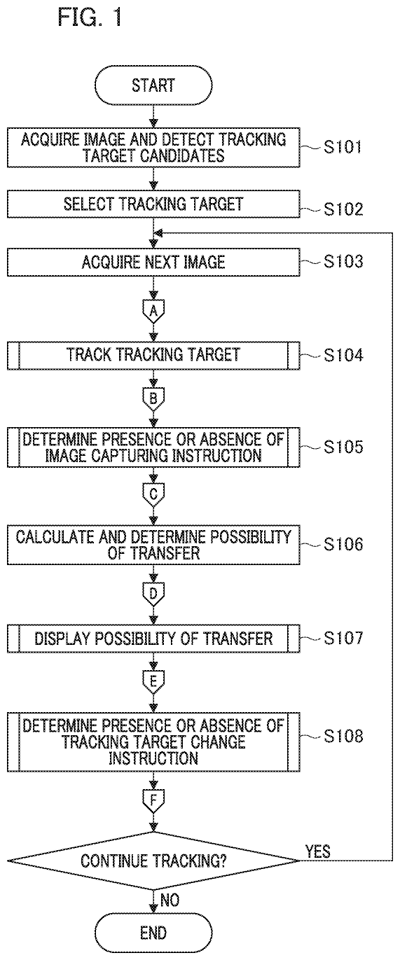

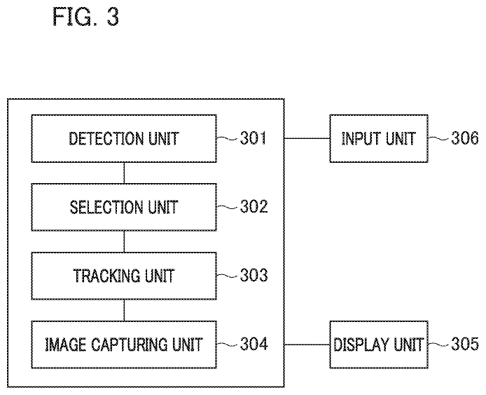

FIG. 1 is a flowchart showing a flow of main processing of the present embodiment. In addition, FIG. 3 is an example of a block diagram showing a configuration of each functional unit that executes processing of FIG. 1. Each functional unit in FIG. 3 is realized by a system control unit of the hardware configuration described below executing processing in accordance with the flowchart of FIG. 1. First, an outline of processing of the present embodiment is explained with reference to FIG. 1 and FIG. 3. Hereinafter, each process (step) is explained by prefixing “S” to the reference numeral.

Together with commencement of photography by a user, processing of S101 is commenced. In S101, a detection unit 301 detects tracking target candidates from an image of a subject to be photographed (a first image).

In S102, a selection unit 302 selects a subject that is to be a tracking target from among the tracking target candidates detected in S101.

In S103, a tracking unit 303 acquires the next image of the subject to be photographed (a second image that is later in time series than the first image).

In S104, the tracking unit 303 similarly detects the tracking target selected in S102 from the image (the second image), and focuses on and tracks the tracking target.

In S105, an image capturing unit 304 determines whether an image capturing instruction by a user has been input.

In S106, the tracking unit 303 calculates and determines the possibility of transfer with respect to the tracking target.

In S107, a display unit 305 displays the possibility of transfer determined in S106 to a user.

In S108, the tracking unit 303 determines whether an instruction for change of the tracking target by the user has been input.

Above-described processing from S103 to S108 is repeated until tracking end is determined based on input from the user. The above is an outline of processing of the present embodiment. Details of the flow of the processing are described below.

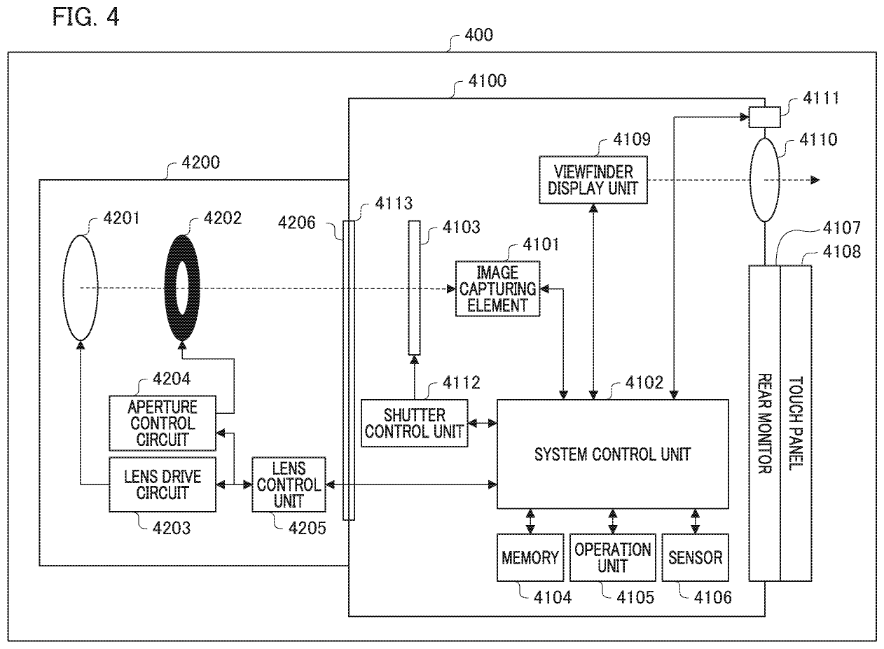

FIG. 4 is a block diagram showing main parts of hardware of an image capturing apparatus 400 (information processing apparatus 400). With reference to FIG. 4, description is provided with respect to a configuration of an image capturing apparatus according to the First Embodiment of the present disclosure.

In FIG. 4, the image capturing apparatus 400 is, for example, an interchangeable lens digital camera, and is configured by a camera body 4100 and a lens unit 4200 that guides incident light to an image capturing element 4101.

First, the camera body 4100 is explained. The image capturing element 4101 is configured by a CMOS imaging sensor, and converts a light signal that is an optical image to an electric signal. A light beam incident on a photographing lens 4201 forms an optical image on the image capturing element 4101 through an aperture 4202 and a shutter 4103.

A system control unit 4102 controls the camera body 4100, and includes a well-known CPU and the like. An image processing unit for video signals obtained by the image capturing element 4101 is further included in the system control unit 4102.

A memory 4104 stores programs, variables, constants, and the like for operation of the system control unit 4102. In addition, the memory 4104 includes electrically erasable and programmable non-volatile memory, in which setting values such as various parameters and ISO sensitivity, as well as a shooting mode, various types of correction data, and the like are stored.

An operation unit 4105 includes operation members such as buttons and dials, and a user can perform photography via the operation unit 4105 and can change camera settings such as a shooting mode.

A sensor 4106 is an apparatus for ascertaining a state of the camera body 4100, and is configured by an acceleration sensor, an angular velocity sensor, and the like. An orientation of the camera body 4100 is correctly determined by the sensor 4106, and information on the orientation is recorded in an image as metadata, or alternatively, the sensor 4106 is also used for processing such as image stabilization and the like.

A rear monitor 4107 is configured by a liquid crystal device, an LED, and the like that display photographing information such as operation states of characters, images, audio, and the like, and messages and the like, in accordance with execution of a program by the system control unit 4102.

A touch panel 4108 is disposed in a region substantially equivalent to the rear monitor 4107, detects contact of a finger or a pen, and notifies a contact position with respect to the rear monitor 4107 to the system control unit 4102, and executes processing of an operation or function associated with the contact position. For this reason, a user can similarly operate the camera body 4100 not only by using the operation unit 4105 but also by using the touch panel 4108.

A viewfinder display unit 4109 displays photographing information in accordance with execution of a program by the system control unit 4102 similarly to the rear monitor 4107, and, together with an eyepiece lens 4110, configures an electronic viewfinder (EVF). In addition, 4111 is an eye proximity detection unit, and the above-described photographing information is selectively displayed by the system control unit 4102 on the rear monitor 4107 or on the viewfinder display unit 4109 in accordance with an eye proximity state of a user.

Next, a configuration of the lens unit 4200 is explained. The camera body 4100 and the lens unit 4200 are mechanically and electrically joined via a lens mount mechanism 4113 and a lens mount mechanism 4206, and are detachable. The lens unit 4200 is configured by the photographing lens 4201, the aperture 4202, a lens drive circuit 4203, an aperture control circuit 4204, and a lens control unit 4205. Although only one photographing lens 4201 is shown in FIG. 4 for simplification, the photographing lens 4201 is actually configured by a large number of photographing lens groups.

The lens control unit 4205 controls the entire lens unit 4200. Although not shown, the lens control unit 4205 is provided with a memory that stores various constants, variables, programs, and the like for lens operation. In addition, the lens control unit 4205 is also provided with a non-volatile memory that holds information unique to the lens unit, such as maximum and minimum aperture values, focal length, and the like.

The system control unit 4102 of the camera body 4100 calculates a defocus amount by using output information of the image capturing element 4101. Then, based on the calculated defocus amount, the system control unit 4102 communicates via the lens control unit 4205 of the lens unit 4200, and performs focusing by controlling the lens drive circuit 4203. Focus can also be adjusted by a user manually rotating a focus ring attached to the lens.

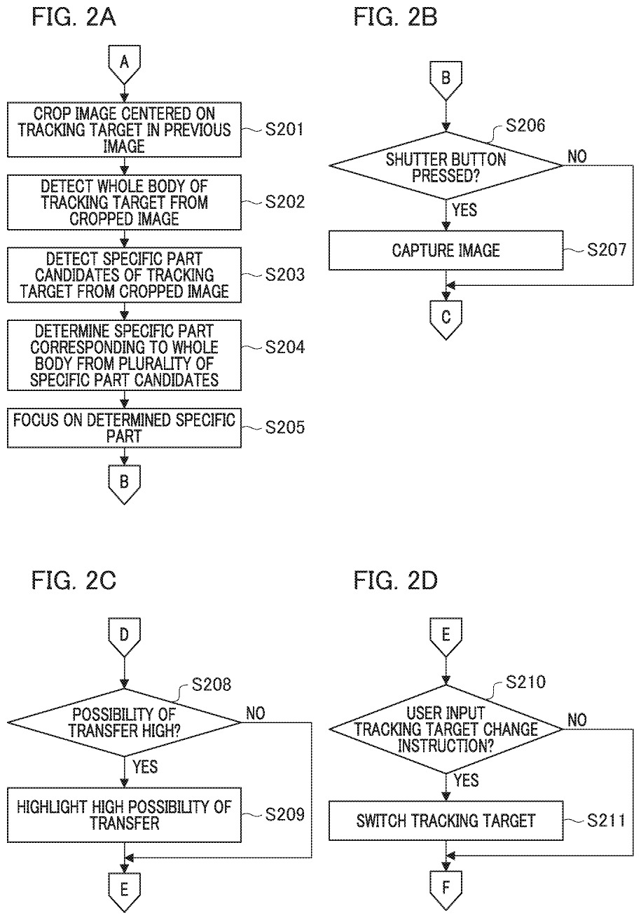

FIGS. 2A to 2D are flowcharts showing detailed processing flows with respect to a portion of processing shown in the flowchart of FIG. 1. Hereinafter, the flowcharts of FIG. 1 and FIGS. 2A to 2D and the functional block diagram of FIG. 3 are used, and details of processing of the present embodiment are explained. As before, each process (step) is explained by prefixing “S” to the reference numeral.

Upon commencement of photography by a user, processing of S101 commences. Here, commencement of shooting refers to, for example, turning on power of a camera and setting the camera to a shooting mode, setting a camera that was in a sleep state to a state in which shooting is possible by pressing a shutter button or the like, in the case of a smartphone, activating a camera application, and the like.

In S101, the detection unit 301 detects tracking target candidates from an image (a first image) captured by the image capturing element 4101. The tracking target candidates to be detected are objects that a user wishes to make into a subject, and are, for example, a person, a dog, a cat, an automobile, and the like. The type may be one or a plurality, and may be set in advance in the camera by a user.

A known machine learning technique is used for detection of tracking target candidates. For example, technology such as a convolutional neural network (CNN) is used, and an object detector capable of detecting objects of a specific type (for example, a person) or portions thereof (for example, a face of a person, an upper body, and the like) is created in advance. The image captured by the image capturing element 4101 is input to the object detector, and tracking target candidates are detected. A detection result may be output as a detection frame (bounding box and the like) surrounding an object.

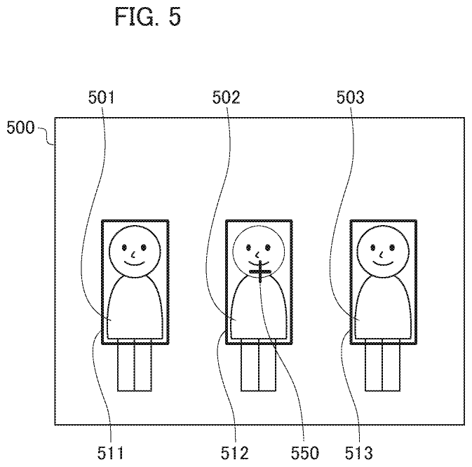

In FIG. 5, an example of detection of tracking target candidates is shown. FIG. 5 shows a result of detecting an upper body of a person 501 shown in the image 500 as a detection frame 511, shows a result of detecting an upper body of a person 502 shown in the image 500 as a detection frame 512, and shows a result of detecting an upper body of a person 503 shown in the image 500 as a detection frame 513. Whether the detection frames are displayed for a user or not is not particularly limited.

In S102, the selection unit 302 selects a tracking target (subject) from among the tracking target candidates detected in S101. A method may be used in which a user stores in advance a face image of a person to be tracked in the memory 4104, and the selection unit 302 detects and selects a person to be tracked from among the tracking target candidates by using an object detector.

A method in which a user inputs a tracking target from an image of tracking target candidates displayed on the rear monitor 4107 is explained by using FIG. 5. In FIG. 5, a user moves the camera, and, in a state in which the cross mark 550 displayed in a superimposed manner on the rear monitor 4107 and the person 502 that the user wishes to make into a tracking target are aligned, half-presses the shutter button. A method in which the camera is fixed and the cross mark 550 displayed in a superimposed manner on a screen is moved may also be used. The selection unit 302 selects a tracking target input to an input unit 306. For input by a user of a tracking target to the input unit 306, a method in which a user can intuitively input may be used, for example, a touch panel, line-of-sight input, and voice input.

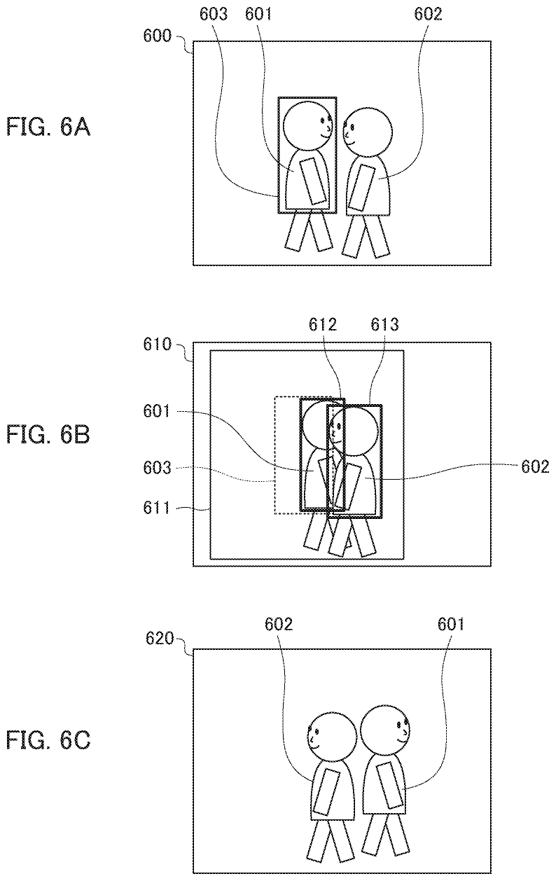

In order to concretely explain subsequent processing, FIGS. 6A to 6C are used. FIGS. 6A to 6C show three consecutive subject images 600, 610, and 620 in chronological order, respectively. A person 601 is walking from left to right in the image, and a person 602 is walking in an opposite direction from right to left in the image. The person 601 and the person 602 intersect at a stage of the image 610 of FIG. 6B. Now, the tracking target selected from the image 600 (first image) in S102 is assumed to be the person 601. Among detection frames of tracking target candidates detected in S101, a detection frame corresponding to the person 601 is 603.

In S103, the tracking unit 303 acquires the next image of the subject to be photographed. Explanation is given by using the example of FIGS. 6A to 6C. The tracking unit 303 acquires the image 610 (second image) of FIG. 6B as the next image.

In S104, the tracking unit 303 likewise detects the tracking target selected in S102 from the image, and tracks the tracking target. Detailed processing of S104 is shown in FIG. 2A. Hereinafter, the processing of S201 to S205 shown in FIG. 2A is explained in order while using FIGS. 6A to 6C.

In S201, the tracking unit 303 cuts out a partial region from the image centered on a position, in the previous image, of the tracking target selected in S102, and generates a crop image. A size for cropping is determined in advance as a ratio with respect to the original image based on a type of a subject and the like. Here, for example, the size is set to four times the area (twice each of the vertical and horizontal dimensions) of the detection frame in which the tracking target was detected.

Here, the reason for generating a crop image is that, by performing subsequent tracking processing with respect to the crop image rather than the entire image, the size of the image to be processed can be minimized, and improvement of tracking accuracy and processing speed can be expected. However, for a purpose such as simplification of processing, and the like, processing may be performed by using the entire image without using a crop image.

The examples of FIGS. 6A to 6C are used for explanation. The tracking unit 303 generates the crop image 611 that is a portion of the image 610 (second image) based on the tracking target detection frame 603 in the previous image 600 (first image).

In S202, the tracking unit 303 proceeds to detect a whole body of the tracking target from the crop image. A “whole body” as used here is a portion that represents an entire form of a subject and that is defined for each type of subject. It is sufficient that the portion is larger than a “specific part” described below and is easier to detect, and for example, in a case in which the subject is a person, the portion may be a whole body including the head to the toes, and may also be an upper body. Although the term “whole body” is used for convenience of explanation, the concept remains the same with respect to subjects that are non-living things, such as an automobile or an airplane, and the like.

For detection, a known object detection technology is used similarly to S101. In a case in which a plurality of whole bodies are detected from within the crop image, a detection frame closest in position to the tracking target in the previous image is adopted. Of course, other known object tracking methods may also be used. For example, such methods include comparing feature amounts obtained from an image, predicting a position in a current image from a movement direction and amount from a past image, and the like. In the present embodiment, the whole body frame detected in S202 is set as the tracking target frame in this image.

The examples of FIGS. 6A to 6C are used for explanation. Whole bodies detected from the image 610 (second image) of FIG. 6B are a frame 612 and a frame 613. Among the frame 612 and the frame 613, because the frame 612 has the smaller distance with respect to the whole body detection frame 603 in the previous image 600 (first image), the frame 612 is adopted as a tracking target whole body.

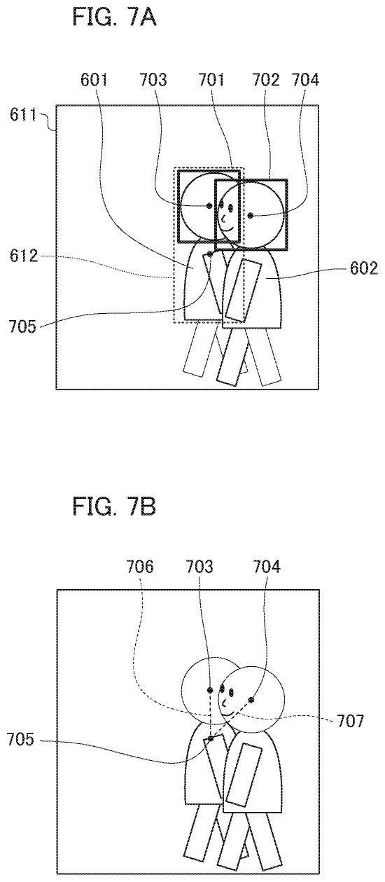

In S203, the tracking unit 303 proceeds to detect one or a plurality of specific part candidates of the tracking target from the crop image. A “specific part” as used here is a portion defined for each type of subject, in which focusing is particularly desired within the subject. For example, in a case in which the subject is a person, the specific parts include a head portion, a face, pupils, and the like. An example is shown in FIG. 7A.

The image 611 of FIG. 7A is the crop image 611 that is a portion of the image 610 (second image) of FIG. 6B. In addition, the whole body detection frame 612 of FIG. 7A is the frame 612 of FIG. 6B. Head portions of persons that the tracking unit 303 was able to detect from the crop image 611 are a frame 701 and a frame 702. The frame 701 and the frame 702 are specific part candidates.

In S204, the tracking unit 303 proceeds to select and determine a specific part belonging to the same object as the whole body detected in S202 from among specific part candidates detected in S203. Using the example of FIG. 7A, the whole body of the person 601 detected by the tracking unit 303 in S202 is the frame 612. Specific part candidates detected by the tracking unit 303 in S203 are the frame 701 and the frame 702. In S204, the tracking unit 303 determines which of the frame 701 and the frame 702 is the head portion of the person 601. In other words, the tracking unit 303 determines which of the frame 701 and the frame 702 is the head portion frame corresponding to the whole body frame 612.

In the present embodiment, an object identification processing technology, disclosed in Japanese Patent No. 7422456, using a pre-trained model that was trained to output a score map corresponding to individuals of a plurality of objects with respect to joint positions, is used. A line segment connecting the whole body and the specific part is defined, and a pre-trained machine learning model is created that assigns, with respect to respective points on the line segment, for example, points obtained by dividing the line segment into five equal parts, scores close in value in a case in which the object is the same, and scores distant in value in a case in which the object is different. Then, scores output by using the pre-trained model are used, and the whole body and the specific part are matched.

Concrete explanation is given by using FIGS. 7A and 7B. A point 703 is the center point of the specific part frame 701. Similarly, a point 704 is the center point of the specific part frame 702, and a point 705 is the center point of the whole body frame 612. In FIG. 7B, a line segment 706 is a straight line connecting the point 703 and the point 705, and a line segment 707 is a straight line connecting the point 704 and the point 705. Furthermore, successive points (not shown) that equally divide each line segment are defined on each line segment. The tracking unit 303 executes inference processing on the crop image 611 by using the above-described pre-trained model, and outputs scores of points on each line segment. The tracking unit 303 compares which of the set of scores of each point on the line segment 706 and the set of scores of each point on the line segment 707 is closer to the score of the whole body center point 705, and by how much.

As a result, the tracking unit 303 determines that the line segment 706, for which the sum of differences between the score of each point and the score of the whole body center point 705 is relatively small, is a more correct pair of the whole body and the specific part. Then, the tracking unit 303 determines that the specific part 701 having the end point 703 of the line segment 706 as the center point is a specific part of the tracking target. It should be noted that, although technology disclosed in Japanese Patent No. 7422456 was used in the present embodiment, a known instance segmentation technology may be used, identification processing of object regions may be performed, and matching of the whole body and the specific part belonging to the same object may be performed based on a result of the identification processing.

In S205, the tracking unit 303 proceeds to focus on the specific part determined in S204. As described above, the tracking unit 303 executes the tracking processing of S104 through steps S201 to S205.

Following S104, in S105, the image capturing unit 304 performs image capturing of an image focused on the tracking target in accordance with user input received by the input unit 306. Specifically, for example, as shown in FIG. 2B, in a case in which the shutter button is fully pressed by a user in S206, the image capturing unit 304 proceeds to S207 and performs image capturing, and in a case in which the shutter button is not fully pressed, processing proceeds to S106.

In S106, the tracking unit 303 calculates and determines the possibility of transfer with respect to the current tracking target. In S204 of S104, the tracking unit 303 determined the specific part corresponding to the whole body of the tracking target. In a case in which the difference in scores calculated at that time was slight, being equal to or less than a threshold, the tracking unit 303 determines that the possibility is high that the specific part is being confused with a specific part of another object, that is, that transfer of the tracking target is occurring, or that the situation is such that transfer is likely to occur. In S106, the tracking unit 303 quantifies and determines the transfer possibility.

Concrete explanation is given by using the example of FIG. 7B. The matching score of the specific part center point 703 with respect to the whole body center point 705 is designated as S1, and the matching score of the specific part center point 704 with respect to the whole body center point 705 is designated as S2. When the ranges of the scores of S1 and S2 are respectively

0<=S1<=255

0<=S2<=255

the transfer possibility score SS can be expressed as:

SS=255−|S1−S2| (1)

As the score difference between S1 and S2 becomes smaller (the difference between the distances from each specific part center point to the whole body center point 705 becomes smaller and the possibility of transfer becomes higher), the transfer possibility score SS becomes larger. Conversely, as the score difference between S1 and S2 becomes larger (the difference between the distances from each specific part center point to the whole body center point 705 becomes larger and the possibility of transfer becomes lower), the transfer possibility score SS becomes smaller.

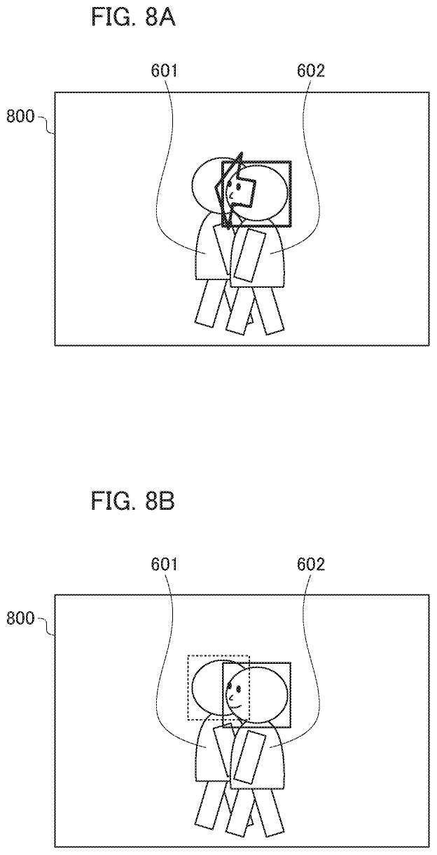

In S107, the display unit 305 displays the calculated possibility of transfer to a user. As shown in FIG. 2C, for example, in a case in which the tracking unit 303 determines that the transfer possibility score SS is higher than a threshold T, in S209, the display unit 305 displays highlighting indicating that the transfer possibility is high. As a method of highlighting, the display unit 305 indicates a direction and position of the other specific part candidate using an arrow or triangle, as in FIG. 8A. Alternatively, as shown in FIG. 8B, the display unit 305 may display the direction of the other specific part using a color or line type different from the frame line surrounding the specific part.

It should be noted that, also in a case in which the tracking unit 303 determines that there are two or more specific part candidates having high possibility of transfer, the display unit 305 may similarly display highlighting with respect to each specific part candidate. Regardless of whether there is one specific part candidate having high transfer possibility or a plurality thereof, the display unit 305 may change the degree of highlighting in stages. For example, the display unit 305 may change strength of highlighting in order of magnitude of the transfer possibility score SS. Alternatively, based on a relationship of distance between a tracking target candidate having high possibility of transfer and the tracking target, the display unit 305 may change the degree of highlighting in accordance with a magnitude of influence that transfer has on photography. In addition, the display unit 305 may use a magnitude of a defocus amount instead of a magnitude of distance to the tracking target. Because the degree of influence that transfer has on photography is conveyed in an easily understandable manner to a user through the degree of highlighting, an instruction for change of the tracking target taking into consideration the influence on photography can be provided. In addition, the possibility of failing photography due to failing to provide an instruction for change of the tracking target can be reduced.

If the transfer possibility score SS repeatedly exceeds or does not exceed the threshold T on a per-image (per-frame) basis, the presence or absence of highlighting switches frequently, and visibility for a user decreases. In order to prevent such decrease in visibility, the threshold may be changed only in a case in which highlighting is canceled, and highlighting end may be made less likely to occur than highlighting start. Although determination of highlighting is made for each image (each frame), canceling of highlighting may be performed only in a case in which the score SS falls below the threshold T consecutively for a fixed number of images (frames).

In S108, the tracking unit 303 changes the tracking target based on user input received by the input unit 306. Specifically, for example, as shown in FIG. 2D, if the user inputs an instruction for changing the tracking target in S210, in S211, the tracking target is switched based on that instruction.

The user input method for instructions is a re-pressing of the shutter button in the present embodiment. In S102, a user selects a tracking target by half-pressing the shutter button, and because tracking continues until the present step, by quickly releasing the shutter button and half-pressing again, the user instructs switching to another tracking target candidate. In a case in which there are a plurality of tracking target candidates to be switched, candidates are switched sequentially in a clockwise direction starting from a candidate closest in distance to the current tracking target.

A different instruction method is also acceptable provided that a user can select quickly and intuitively. For example, methods include sequential switching by tapping on a touch panel, tapping of a switching destination, flicking in a switching direction, input of a switching destination direction by using a stick-type input device, and the like. Alternatively, sequential switching of tracking target candidates by rotating a focus ring, instruction of a switching destination by voice input, and the like, are also acceptable.

Above-described processing from S103 to S108 is repeated until tracking end is determined based on input from a user. The input for tracking end includes releasing a shutter button for a fixed time or longer, changing a mode setting of a camera, and the like.

According to the above-described embodiment, a situation in which the possibility of transfer of the tracking target is high can be quickly conveyed to a user. In addition, in a case in which the possibility of occurrence of transfer is high for a user, by instructing a change of the tracking target, tracking can be continued even in a scene in which subjects intersect. In addition, focusing can be continued on a subject a user wishes to photograph, and taking a photograph as the user intended becomes easier. That is, in a case in which transfer is likely to occur during tracking of a subject, or in a case in which transfer is occurring, it becomes possible to provide information for a user to quickly take action.

### Modification 1 of First Embodiment

As Modification 1 of the First Embodiment, an example is shown in which conventional switching display of a tracking target is highlighted. Hereinafter, Modification 1 is explained focusing on differences from the First Embodiment.

As a conventional camera capable of tracking a subject, there exists a user interface (UI) capable of switching a tracking target as follows. In each image (each frame), in processing corresponding to S101 of FIG. 1, the detection unit 301 detects tracking target candidates. By displaying tracking target candidates different from a subject being tracked, the tracking target (AF target) can be switched. Specifically, the interface is a UI in which, when different tracking target candidates are being displayed, the tracking target can be switched by input of a direction of a tracking target candidate different from the tracking target by using a stick-type input device, or by pressing of a button.

The present modification can be implemented in addition to the above-described conventional display. That is, in addition to conventional display for switching a tracking target, switching display of a tracking target in a case in which the possibility of transfer is increasing is highlighted more than a conventional display method.

Tracking target candidates different from a subject being tracked in conventional display are tracking target candidates detected by the detection unit 301. In contrast, tracking target candidates having a high possibility of transfer are tracking target candidates that the tracking unit 303 is likely to confuse with the tracking target in the object identification processing described above. In the present modification, tracking target candidates having different detection methods are displayed differently.

By changing display based on detection method in this manner, in a case in which an instruction for change of a tracking target is input, a user can easily grasp what kind of tracking target change will be performed merely by looking at the display. That is, in a case in which subjects other than a subject being tracked are displayed normally, an instruction for change of a tracking target can be determined to be an input for switching tracking to a subject different from a subject being tracked.

In contrast, in a case in which subjects other than a subject being tracked are highlighted using arrows, triangles, and the like that are different from normal display, a determination can be made that the display indicates the possibility that transfer of tracking is occurring. In particular, in a case in which transfer of tracking has occurred, a subject a user originally wishes to track is highlighted, and accordingly, the user can immediately perform an instruction for change of a tracking target.

According to Modification 1 of the First Embodiment explained above, because switching display of the tracking target is highlighted based on possibility of transfer occurrence, a user can easily grasp the possibility of transfer occurrence, and can easily change a tracking target.

### Modification 2 of First Embodiment

As Modification 2 of the First Embodiment, an example is shown with respect to automatically canceling highlighted display in a case in which a user ignores highlighted display with respect to transfer possibility and a fixed time elapses. Hereinafter, Modification 2 is explained focusing on differences from the First Embodiment.

In the present modification, even in a case in which, in S106 of FIG. 1, the tracking unit 303 calculates and determines the possibility of transfer, and in S107, the display unit 305 displays the transfer possibility, there are cases in which a user determines that change of a tracking target is unnecessary. That is, although the transfer possibility is high, there are cases in which transfer has not actually occurred. Taking such cases into consideration, in a case in which a user does not provide an instruction such as input and the like for a fixed time with respect to highlighted display indicating high transfer possibility, the display unit 305 cancels or suppresses the highlighted display. Furthermore, in a case in which the number of specific part candidates detected in S203 differs from a previous frame, the display unit 305 restarts highlighted display so that a user can make a new determination.

According to Modification 2 of the First Embodiment explained above, by automatically canceling highlighted display under specific conditions, continuing unnecessary highlighted display despite a user determining that change of a tracking target is unnecessary can be avoided. In addition, photography can be continued without a user going to the trouble of canceling highlighted display.

### Modification 3 of First Embodiment

As Modification 3 of the First Embodiment, an example is shown with respect to changing depth of field by means of aperture adjustment in addition to highlighting that the transfer possibility is high, or instead of highlighting. Hereinafter, explanation is provided focusing on differences from the First Embodiment.

In the present modification, in a case in which, in S108 of FIG. 1, a user does not input an instruction for switching a tracking target for a fixed time, the tracking unit 303 adjusts the aperture 4202 so that all specific part candidates having high transfer possibility are in focus. In S108 of FIG. 1, the tracking unit 303 records presence or absence of a switching instruction for a tracking target by a user. In S104, in which the next and subsequent images (frames) are processed, the tracking unit 303 compares a length of a period during which highlighted display indicating that the transfer possibility is high was performed, and a record of presence or absence of a switching instruction by a user with respect to the period. In a case in which highlighted display was performed as is for a period equal to or longer than the threshold in a state in which a switching instruction by a user is not provided, the tracking unit 303 stops down the aperture 4202. Thus, a user can prevent failure of photography due to transfer of a tracking target without going to the trouble of input of change of the tracking target.

Instead of a case in which highlighting was performed as is for a period equal to or longer than a threshold, the condition for changing the depth of field may be a case in which a user did not explicitly cancel highlighting. In this manner, in a case in which a user determines that there is no problem with the current tracking target, an unintended change of depth of field can be avoided.

On the condition that continuous shooting is in progress due to a full press of the shutter button or the like by a user, the depth of field may be changed. Alternatively, in a case in which specific part candidates having high transfer possibility are numerous, depth of field may be changed without waiting for input by a user.

After changing the depth of field, in a case in which a user inputs change of a tracking target, the depth of field may be returned to the original state. Alternatively, without performing highlighting in the first place, the aperture may be automatically adjusted to stop down in a case in which specific part candidates having high transfer possibility exist. In this case, in exchange for elimination of room for determination by a user, photographic failure due to focus shift can be further reduced.

According to Modification 3 of the First Embodiment explained above, even in a case in which transfer occurs in a scene in which tracking is difficult, such as a scene in which subjects intersect, focusing can be continued on a subject without input of an instruction for change of a tracking target by a user.

In the present embodiment, realization is also possible by processing in which a program for realizing one or more functions is supplied to a computer of a system or an apparatus via a network or a storage medium, and a system control unit of the system or the apparatus reads out and executes the program. In addition, realization is also possible by a circuit (for example, an ASIC) that realizes one or more functions.

Although the preferred embodiments of the present disclosure have been explained above, the present disclosure is not limited to these embodiments, and various modifications and changes are possible within the scope of the gist thereof.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-069914, filed Apr. 21, 2025, which is hereby incorporated by reference herein in its entirety.

What is claimed is:

1. An information processing apparatus comprising:
at least one memory storing instructions; and
at least one processor executing the stored instructions causing the information processing apparatus to:
detect tracking target candidates from each of a first image and a second image later in a time series than the first image;
select a tracking target from the tracking target candidates;
track the tracking target and determine a possibility of transfer of the tracking target; and
perform highlighting for a user based on the possibility of transfer of the tracking target.

2. The information processing apparatus according to claim 1, wherein executing the stored instructions by the processor further causes the information processing apparatus to:
perform AF control with respect to the tracking target, and perform image capturing.

3. The information processing apparatus according to claim 1, wherein executing the stored instructions by the processor further causes the information processing apparatus to display a direction of the tracking target candidates having a high possibility of the transfer.

4. The information processing apparatus according to claim 1, wherein executing the stored instructions by the processor further causes the information processing apparatus to display the tracking target candidates having a high possibility of the transfer in frames surrounding the tracking target candidates.

5. The information processing apparatus according to claim 1, wherein executing the stored instructions by the processor further causes the information processing apparatus to change the tracking target based on an instruction from a user.

6. The information processing apparatus according to claim 1, wherein executing the stored instructions by the processor further causes the information processing apparatus to suppress the highlighting based on an instruction from a user.

7. The information processing apparatus according to claim 1, wherein executing the stored instructions by the processor further causes the information processing apparatus to change depth of field based on the possibility of transfer of the tracking target.

8. The information processing apparatus according to claim 5, wherein executing the stored instructions by the processor further causes the information processing apparatus to control a change of depth of field based on an instruction from a user for a change of the tracking target.

9. The information processing apparatus according to claim 1, wherein executing the stored instructions by the processor further causes the information processing apparatus to change a degree of the highlighting based on a relationship between the tracking target candidates having a high possibility of the transfer and the tracking target.

10. The information processing apparatus according to claim 1, wherein executing the stored instructions by the processor further causes the information processing apparatus to determine the possibility of the transfer based on a score of correspondence between a whole body of the tracking target and specific part candidates of the tracking target, wherein the whole body and the specific part candidates are detected from each of the first image and the second image.

11. An information processing method executed by an information processing apparatus, the method comprising:
detecting tracking target candidates from each of a first image and a second image later in a time series than the first image;
selecting a tracking target from the tracking target candidates;
tracking the tracking target and determining a possibility of transfer of the tracking target; and
performing highlighting for a user based on the possibility of transfer of the tracking target.

12. A non-transitory storage medium storing a program of an information processing apparatus, the program causing a computer to perform each step of an information processing method executed by the information processing apparatus, the method comprising:
detecting tracking target candidates from each of a first image and a second image later in a time series than the first image;
selecting a tracking target from the tracking target candidates;
tracking the tracking target and determining a possibility of transfer of the tracking target; and
performing highlighting for a user based on the possibility of transfer of the tracking target.
